(19) United States
(12) Patent Application Publication
(10) Pub. No.: US 2006/0287471 A1
(43) Pub. Date: Dec. 21, 2006

(54) Accelerated acetaldehyde testing of polymers

(76) Inventors: Benjamin R. Schreiber, Johnson City, TN (US); Eric Gray Olsen, Kingsport, TN (US); Steven Lee Stafford, Gray, TN (US); Jack L. Hensley, Kingsport, TN (US); Donald C. Ellison, Kingsport, TN (US)

Correspondence Address: Eastman Chemical Company, P.O. Box 511, Kingsport, TN, 37662-5075, US

(21) Appl. No.: 11/154,146

(22) Filed: Jun. 16, 2005

(51) Int. Cl. C08G 63/02

(52) U.S. Cl. 528/272

(57) ABSTRACT

An acetaldehyde screening method is developed by feeding solid polymer sample particles having a free acetaldehyde (“AA”) content of 2 ppm or less, melting at least a portion of the sample particles to obtain a polymer sample having a heat history, and thereafter measuring the amount of acetaldehyde present in the polymer sample having the heat history. There is also provided a screening method in which the quantity of free or residual AA in or on a polymer sample is measured to obtain a first value AAf, the sample is melted, and thereafter the amount of AA generated upon remelting the polymer is measured to obtain a second value AAg.

### FIELD OF THE INVENTION

The present invention relates to a technique and apparatus for screening the acetaldehyde generation rate of thermoplastic polymers in small quantities without the necessity for molding the polymers and thereafter measuring their residual acetaldehyde content.

### BACKGROUND OF THE INVENTION

In a melt phase process for the production of polyester polymers, acetaldehyde is formed as free or residual acetaldehyde. Acetaldehyde is undesirable because it imparts a noticeable taste, problematic in carbonated soft drink and water packaging. Likewise, acetaldehyde precursors are manufactured in the melt phase production process that have the potential for reacting at a later time upon remelting, such as in an injection molding machine, to produce additional quantities of acetaldehyde. This latter phenomenon is known as the generated acetaldehyde. This, the total amount of acetaldehyde that is present in a preform or bottle is a measure of the free or residual acetaldehyde present in the pellets fed to the molding machine or other extrusion equipment used for making an article, plus the generated AA, which combined will yield the total AA present in the preform or bottle.

More specifically, the first source of AA, free or residual AA, is produced in the melt phase process for manufacturing the polymer. Most of this will be removed if a solid-stating process is used to build up the polymer's molecular weight. It is the actual measurable amount of acetaldehyde present in polyester polymer pellets that have not undergone a melt history. The amount of free acetaldehyde from melt phase manufacturing that would end up in a preform would be indicated by the level of free AA in the pellets exiting the dryer prior to entering the extruder of the injection molding machine.

In the melt phase process for manufacturing the polymer, acetaldehyde precursors, such as species having vinyl end groups, are also produced. The second source of acetaldehyde is the additional amount generated when the polyester polymer solids are melted in a melt processing zone (such as an extruder or injection molding machine) by converters to make bottle preforms. Acetaldehyde precursors present in the solids are converted to acetaldehyde under melting conditions to generate a higher acetaldehyde level than was originally present in the solid polyester polymers fed to the melt processing zone. The additional melt history in the processing zone can result in more thermal degradation of the polyester chain. Additional acetaldehyde precursors can be formed and reacted to form acetaldehyde. The rate at which AA is formed upon melting solid polyesters is known as the acetaldehyde generation rate. Because of this, it is possible to reduce the amount of residual or free acetaldehyde present in the pellets to a value of 3 parts per million or less and yet produce a preform, made in an injection molding machine with a barrel temperature of 285° C. and a melt residence time of about 108 seconds, containing high levels of acetaldehyde in excess of 13 parts per million. When the preforms are blown into bottles, the high acetaldehyde levels can adversely impact the taste of the beverage contained in them.

It has been customary to measure the AA level in a preform or bottle because measuring AA present in a preform or bottle takes into account both the free AA on or in the pellets and the AA generated in the barrel of an extrusion zone upon melting the pellets. To determine the total AA present in the preform, however, requires one to expend the resources necessary to make sufficient quantities of polymer and purchase the commercial equipment to make the preforms or bottles. Thus, the manufacturer of polyester polymer has to obtain a variety of preform molds (depending on bottle size) and related injection molding equipment which is quite expensive, or sample customers who possess injection molding equipment for evaluation purposes which is a lengthy process. Moreover, even if the polymer manufacturer possess the proper equipment, large quantities of developmental polymer have to be produced to make a batch of preforms with acceptable quality that would approach a commercial injection molding line.

It would be desirable to develop a technique and assembly that is fed with only small amounts of polymer and which generates AA measurement data predicting the trends observable on testing the AA levels in molded articles, and even more desirably, which will correlate well with detecting the level of AA in molded articles such as preforms. Testing the level of free AA on pellets has heretofore been inadequate because such test methods only detect the level of free AA on or in the pellet and does not take into account the additional AA that would be generated upon melting the pellets in the injection molding machine or other machines which impart a melt history prior to manufacturing the molded articles.

### SUMMARY OF THE INVENTION

There is now provided an acetaldehyde screening method comprising providing solid polymer sample particles having a free acetaldehyde (“AA”) content of 2 ppm or less, melting at least a portion of the sample particles to obtain a polymer sample having a heat history, and thereafter measuring the amount of acetaldehyde present in the polymer sample having the heat history.

In another embodiment, there is provided a screening method comprising measuring the quantity of free or residual AA in or on a polymer sample to obtain a first value AAf, melting the sample, and thereafter measuring the amount of AA generated upon remelting the polymer and obtaining a second value AAt, in which the difference between AAt and AAf represents the level of AA generated (“AAg”).

### DETAILED DESCRIPTION OF THE INVENTION

Small amounts of thermoplastic material are required to screen the level of total acetaldehyde which would be present in a molded article. For example, less than 2.5 kg, or less than 1 kg, or less than 100 g, or less than 50 g, or even less than 15 g of material is required to obtain screening data.

The screening test may be performed in an extrusion plastometer. Melt residence time can be regulated by varying the amount of time the polymer resides in the barrel. Semi-automated extrusion plastometers, such as the Ceast Model 7027 Modular Melt Flow instrument, reduce variability of residence time in the barrel by maintaining consistent hold times. This reduction in test variability allows for smaller differences between samples to be detected. Laboratory scale injection molding equipment or extruders, such as a Mini-Jector Model #55-1, can further reduce test variability by more fully automating the processing technique; however, this equipment usually requires more material than an extrusion plastometer.

The screening method of the invention and the assembly tests the AA generation rate of polyester resins while using small quantities of material. The method provides trends, and data from the method can be used to predict residual AA in bottle preforms without needing to make the article (e.g. preforms) by using correlations obtained previously by both treating polymers according to the screening method of the invention and by molding articles such bottle preforms from the same polymers.

In a first screening method, processed material is cryogenically ground. This material is analyzed according to ASTM Method F2013-00, “Standard Test Method for Determination of Residual Acetaldehyde in Polyethylene Terephthalate Bottle Polymer Using an Automated Static Head-Space Sampling Device and a Capillary GC with a Flame Ionization Detector”. In a second screening method, the processed material is cryogenically ground before and after processing. In both cases, the material is analyzed according to ASTM Method F2013-00, Cryogenic grinding of the samples both prevents the AA in the sample from volatizing during grinding while allowing more accurate measurement of AA within the sample during GG analysis. Laboratory scale quantities of material can be evaluated for acetaldehyde generation rate with any type of extrusion plastometer, and the screening test as described below predicts trends and can also be used to predict the level of AA present in a molded article such as a bottle preform based on correlations between the screening test results and bottle preform results obtained on a series of polymers.

Suitable devices for melting polyester polymers in a controlled manner include extrusion plastometers and laboratory scale injection molding equipment or extruders. Preferred is an extrusion plastometer. The tests using extrusion plastometers or laboratory scale injection molding equipment or extruders require much smaller quantities of material than injection-molding bottle preforms for testing.

In one embodiment, there is provided an acetaldehyde screening method comprising providing a solid polymer sample particles having a free acetaldehyde (“AA”) content of 2 ppm or less, melting at least a portion of the sample particles to obtain a polymer sample having a heat history, and thereafter measuring the amount of acetaldehyde present in the polymer sample having the heat history. The solid particles submitted to the screening method have already seen a heat history during their manufacture in a melt phase polycondensation reaction, therefore, the solid polymer samples are actually experiencing a second melt history when melted in the screening method of the invention.

In another embodiment, there is provided a screening method comprising measuring the quantity of free or residual AA in or on a polymer sample to obtain a first value AAf, melting the sample to obtain a polymer sample having a heat history, and thereafter measuring the amount of AA generated in the polymer sample having the heat history to obtain a second value AAt. The total amount of AA present in the polymer sample having the heat history AAt less the AAf value represents the AA generated (“AAg”) during the melt history, or in other words, AAg=AAt−AAf. The same type of polymer made under the same conditions is used to measure AAF and AAt.

In a preferred embodiment, the screening test of the invention has an initial step of reducing the AAf of the polymer sample to less than 2 ppm, and is preferably 1 ppm or less to ensure that the AAg value obtained in the test represents solely the amount of AA generated instead of the cumulative total of free AA and AA generated. In this case, AAt is about the same as AAg. If the AAf is greater than 2 ppm, a vacuum oven treatment is developed to remove the AAf from the worst case by initially testing AAf before and during the vacuum oven treatment. Once the oven treatment is established, the AAf prior to processing is tested only if the particle size changes appreciably or the present case is thought to have an even higher AAf than the worst case used to develop the oven treatment. Removal of AA to reduce the AAf to below 2 ppm is not limited to an oven treatment. Any method useful to reduce the AA levels of solids to below 2 ppm is suitable.

The sample tested is a polymer. The polymer is preferably thermoplastic. The thermoplastic polymer sample is solid at 25° C. and 1 atmosphere. The sample preferably represents a sample which no longer requires any further chemical treatment or modification to the backbone of the polymer or the addition of additives. If the samples do not represent the finished polymer, the values obtained may not be representative of how the ultimate commercial polymer would perform in a molding machine.

The sample is also provided in a form of particles. The particles may be pellets or powder. The particles may have an average particle size of 10 mm or less in their longest dimension, or 5 mm or less, or 3 mm or less, or 0.5 mm or less, or 0.01 mm or less, or 10,000 nm or less, or 5000 nm or less, or 1000 nm or less on average. In one embodiment, the powder is made to pass through a 3 mm screen.

In the first step of the invention, a solid polymer having a free AA (AAf) content of 2 ppm or less is provided. The sample may be manufactured with an AAf of 2 ppm or less, or the AAf content may have to be reduced if the AAf is more than 2 ppm, or the AAf content can be reduced even if the sample has an AAf content below 2 ppm if one desires further reduction. As a matter of routine practice, it may be more desirable to establish a procedure which ensures reduction of AA content of polymer to 2 ppm or less regardless of the AA content of the sample to avoid the time and disruptions caused by obtaining AAf measurements of the sample submitted to melting.

Thus, in a preferred embodiment, the AA content of the solid polymer sample is reduced by treating the polymer samples to reduce the content of the AA to 2 ppm or less, thereby avoiding the need to measure the initial AA content of the sample. To reduce the level of AA of a solid polymer sample, the solid sample may be stripped of AA by any known technique at the time, preferably by stripping off volatiles in a vacuum oven.

At least a portion of the polymer sample is preferably first ground to a powder before subjecting the sample to AA reduction, if any, or at least before remelting. A portion of the sample polymer may be ground to a powder and made to pass through a 5 mm, and more preferably through a 3 mm screen.

Any suitable technique for AA reduction, if necessary, may be used. If AA reduction is provided, the sample, preferably a ground powder, is stripped to remove residual or free AA in an oven set at a temperature above the Tg, and preferably not more than about 50° C. above the Tg but at least 20° C. below the melting temperature of the polymer. The temperature should not be set so high that the polymer reacts and thereby provides a false AA reading. For example, at 180° C., unreacted ingredients in the polyester polymer may react during a 24 hour period to produce AA; thereby resulting in a false reading. For example, the samples may be stripped at about 100° C. to about 160° C., or even at the lower end of the temperature range such as at 105° C. to 125° C. or about 115° C, especially if assisted by a vacuum (e.g. 15-30 in. Hg), optionally with a purge from nitrogen or another inert gas. The acetaldehyde removal temperature should not exceed a temperature which softens or imparts a partial melt history, and in the case of polyethylene terephthalate polymers and copolymers, generally does not exceed 170° C. for extended periods of time when the samples are obtained from a melt phase polycondensation process without solid state polymerization. If these polymers are stripped at temperatures around 190° C., it should only be for a short amount of time, not to exceed a couple of hours. The short amounts of time at temperatures around 190° C. are sufficient for water removal and should preferably be used only with solid-stated polymers, which usually do not have AA above 2 ppm. The water level should be reduced to about 50 ppm or less prior to melting polymer due to the It.V. loss from hydrolysis that occurs when wet polymer is melted.

In the case of solid state polymerized polyester samples, suitable stripping times are about 16 hours or more. In the case of polyester samples polymerized in the melt phase only, suitable stripping times are about 48 hours or more The amount of time for stripping, and the stripping conditions employed, are flexible and not limited so long as the sample residual AA is reduced to 2 ppm or less. The AA reduction conditions are preferably selected to ensure reduction of AA to less than 2 ppm in any grade of polymer tested to avoid the necessity for taking AA measurements before running the analytical test on the remelted polymer. For example, although overnight stripping would be sufficient for water removal alone, an extended oven treatment also serves to ensure removal of residual acetaldehyde to levels of 2, preferably 1 part per million or less prior to acetaldehyde generation testing in the case of partially aromatic polyester polymers having repeating units of ethylene terephthalate or ethylene naphthalate. The water level should be reduced to about 50 ppm or less prior to melting polymer due to the It.V. loss due to hydrolysis that occurs when wet polymer is melted. It takes longer to remove residual acetaldehyde from pellets to this level than it does for powders, due to the larger particle size (longer diffusion path). In the case of pellet polyester samples polymerized in the melt phase only, suitable stripping times are about 72 hours or more For this reason, the preferred sample preparation technique includes grinding to a powder, especially when residual AA levels are moderate to high. However, loading or feeding the processing equipment is easier with pellets. Pellets are preferred if the residual AA is low.

Once a solid polymer sample having less than 2 ppm free AA is provided, in the next step, the sample is melted and held for a time sufficient to generate AA. Although the solid particles are melted, in many instances the melting step in the screening process of the invention is the second melt history the polymer has experienced. The polymer may have already seen a first melt history in the course of its manufacture and molecular weight increase during the manufacturing step. However, in the screening method of the invention, the melting step represents the first melt history starting from solid polymer particles.

Suitable melting temperatures will depend on the nature of the polymer. The temperature should not be so high as to thermally degrade the polymer. Preferably, the melting temperature should be within a range to simulate molding conditions, and more preferably at the upper end of a molding condition temperature range. In the case of polyester polymers, the melting temperature is suitably within a range of 265° C. to 300° C. Higher temperatures pose the risk of thermally degrading polyester polymers. Lower temperatures generally do not simulate the molding conditions for making preforms. The most consistent results are obtained between 275° C. and 295° C. in the case of polyethylene terephthalate polymers and copolymers.

Suitable residence times are at least 3 minutes and longer than 15 minutes is not necessary. Longer times pose the risk of thermally degrading polyester polymers, especially at the higher end of the temperature range specified. Alternatively, the residence time ranges from 4 to 10 minutes, or about 5 to 7 minutes. The range between about 5 to 10 minutes shows the best repeatability and distinction between materials.

In one embodiment, the residence time desirably corresponds to actual total cycle times (less cooling in the mold) during the molding of articles, such as would be found for injection molding preforms. Longer residence times are acceptable but unnecessary.

After the solid polymer sample particles have been melted at melt temperatures for a time sufficient to generate AA, the sample having this heat history is subjected to any analytical technique known at the time to measure the content of AA. The molten sample is first solidified and held in a state which diminishes or prevents the further generation of AA and the loss of AA already generated until the sample is subjected to analytical testing. For example, the molten polymer may be extruded or forced from the melt chamber into a bath of cold liquid, such as an ice water bath, ground, and then placed in sub-zero Celsius conditions until the sample is ready to be analytically tested.

The preferred analytical method used in the screening method of the invention is the customary method used to determine the level of AA on any sample, whether a powder, pellet, preform or bottle or any other form. This test method used to determine the total level of acetaldehyde in the polyester polymer composition on any sample is described in ASTM #F2013-00. This preferred test method will continue being preferred as the standards are modified under ASTM #F2013-00. Other analytical techniques are also suitable, including the French National test method.

For measuring the acetaldehyde generation rate on molded articles such as preforms, it is sufficient to use this ASTM #F2013-00 method as described above without subjecting the articles themselves to a further melt history since the solid polymer particles have already been subjected to a melt history by feeding them to an extruder prior to injection molding. By melt extruding or injection molding, acetaldehyde precursors in the polymer melt have the opportunity to covert to acetaldehyde. Some of the AA precursors could have been present in the solid particles prior to melting via at least a portion of manufacturing occurring in the melt phase. Some of the AA precursors are newly formed at the temperatures used during the melt extruding or injection molding processes.

The following technique is an example of how the powder may be remelted and held for a time sufficient to generate AA. After providing a sample having less than 2 ppm AA, the sample is packed in a preheated extrusion plastometer using a steel rod. The orifice die is calibrated according to ASTM D 1238. A small amount of material is purged out the bottom, which is then plugged. The piston rod assembly is put in the top of the barrel. A 225 g weight may be placed on top of the piston rod to hold the rod down inside of the barrel. The polymer is held at 295° C. for 5 minutes. The orifice plug is then removed from the bottom of the barrel. Using a large weight and operator pressure on the top of the piston rod, the polymer is pushed out of the barrel into an ice water bath. This is then patted dry and cryogenically ground to a particle size of less than 800 microns. This may be accomplished by grinding the sample through a Wiley Mill equipped with a 1.0 mesh screen. If one desires to immediately test the sample, the sample need not be placed in sub-zero Celsius conditions for preservation. For example, a portion of a sample (e.g. 0.20 g) may be immediately weighed into a 20-mL vial, sealed and then heated to a temperature between about 10° C. above the Tg of the polymer and about 20° C. below the melting point of the polymer as determined by DSC on a first heat scan at a heat up rate of 10° C./min. In one embodiment, the polymer is heated to about 130 to 170° C., or between about 145° C. to about 155° C., or at about 150° C. in the case of polyester polymers and in particular polyethylene terephthalate polymers and copolymers. The polymer should be heated for a time sufficient to volatize substantially all of the AA from the polymer which can be determined experimentally when the amount of AA accumulating into the head space reached equilibrium. After heating, the gas above the sealed sample is injected onto a capillary gas chromatograph column. The acetaldehyde is separated, and the parts per million of acetaldehyde present in the sample is then calculated. The GC test is repeated. In cases where there may be contamination of the second test from a slow eluting component of the first test, a blank test (no sample added) is inserted between the duplicates. The average amount of acetaldehyde calculated from the duplicate tests is proportional to the average AA generation rate at temperatures over a particular time period.

Other techniques for melting the powder and providing a residence time are also suitable. For example, a Ceast Model 7027 Modular Melt Flow instrument or any similar semi-automated extrusion plastometer can be used.

In a preferred embodiment using an extrusion plastometer, an acetaldehyde generation program is initiated that will maintain a temperature of 295° C. and will extrude the melted polyester material in, for example, 5 minutes at a constant flow rate. The automated functions of this instrument reduce test variability by maintaining consistent contact times for the polymer once it is inside the extrusion barrel. A Ceast Model 7027 model of instrument incorporates automated packing of the resin at the start of the test procedure. The instrument is equipped with a motorized platform that will push the material out of the barrel until the piston is at a specified height above the bottom of the barrel. The platform will then hold the piston rod in place, allowing the resin to heat up and generate acetaldehyde. At the end of the specified hold time, the platform extrudes the remainder of the resin out of the barrel while traveling at a constant speed. These steps eliminate the possibility of variability in results from packing the material through the final extrusion step. Variability in loading the polymer is reduced, but not eliminated, with the design of the barrel. As the extrudate is pushed out of the barrel and into an ice water bath, the sample is collected, patted dry, cryogenically ground, sealed in a bag, and placed in a freezer until the ASTM #F2013-00 test is performed.

Another alternative method to using extrusion plastometers as described above is the use of laboratory scale extruders or injection molding machines. With either type of instrument, the polymer can be given a melt history with tightly controlled temperatures and times. In this case, however, a larger amount of material is required than with extrusion plastometer processing which is capable of detecting the AA level on about 10 to 15 grams of material. With lab scale extruders or injection molding machines, about 80-220 grams, or typically about 100 g-120 g of material is used for each sample. Thus, in one embodiment, the screen method employs sample material in an amount of 220 grams or less, or 120 grams or less, or 50 grams or less, or 20 grams or less or even 15 g or less.

A Mini-Jector Model #55-1 type injection molding machine has been found to be quite suitable for generating acetaldehyde in polyester resins. It will operate over the same temperature range as described with the extrusion plastometers (265 to 300° C.).The length of time that the polymer is held inside the injection barrel is equivalent as well, showing good repeatability over the range of 2 to 15 minutes with the best results obtained at 5 minutes. Polyester materials are loaded into the feed hopper of the Mini-Jector following the drying procedure. Material is extruded into the injection barrel, filling it completely, and then immediately purged. This purging procedure is repeated a second time. Material is then extruded into the injection barrel and held for a total of 5 minutes at 285° C. It is then injection molded into a steel mold at a temperature between 20 and 30° C. Injection pressure is set to 1000 pounds per square inch and held for 30 seconds during the injection. The sample is immediately removed from the mold, cryogenically ground, and kept in a freezer until the ASTM #F2013-00 test is performed.

Use of these methods for the determination of acetaldehyde generation rate allow for screening of polyester resins for acetaldehyde generation without needing large amounts of material for evaluation, such as molding of bottle preforms. As little as 10 g of material (100 g for laboratory scale injection molding or extruding) may be used in this process making it ideal for testing of polymers made on the laboratory scale. Using these methods allows one to quickly screen process conditions, catalysts, additives, etc. for the impact on acetaldehyde generation rates. In the second embodiment, the residual or free AA, AAf, can be measured by using the same analytical technique on a sample which is not prepared in any manner other than to grind the sample to a powder and to remove residual water in excess of about 50 ppm based on the weight of the polymer. For example, the sample would be dried in a vacuum oven (25-30 in. Hg) with a nitrogen sweep of 4 SCFH for 16 h at 115° C. The sample is dried to avoid an IV loss during melting. In this embodiment, the AAf is be measured on a sample obtained after drying is complete. If one cannot take the measurement at that time, the sample should be frozen. Once the AAf sample is obtained, then the remainder of the sample is prepared according the methods stated above to obtain a AAt value, with the difference between both values representing the AA generated, and the AAt representing the total amount of AA one would expect to see on a molded article made without a preceding stripping.

### EXAMPLES

### Example 1

The method used to process polyester materials for acetaldehyde generation involves several steps. The materials are first dried to remove both moisture and any residual acetaldehyde. To accomplish this, a vacuum oven is used. For solid-stated materials, the samples are placed inside of the vacuum oven for a minimum of 16 hours at a temperature of 115° C. Solid-stated material has already had much of the residual acetaldehyde removed during the solid-stating process. The amount of vacuum being pulled on the oven chamber is between 25 and 30 inches of mercury. A nitrogen purge is used to sweep moisture and acetaldehyde away from the polyester samples. This is set at a level of 4 standard cubic feet per hour. Melt-phase materials are dried in the same manner for a period of not less than 48 hours. The longer drying time for material with molecular weight build-up virtually exclusively in the melt phase is required to remove the higher level of residual acetaldehyde found in this type of material. Following drying of the material, the polyester is processed with an extrusion plastometer. The plastometer is cleaned thoroughly prior to loading samples into it. Orifice dies are cleaned completely of any residual resin and placed at the bottom of the plastometer barrel once they have been cleaned. The barrel temperature is set to 295° C. and is within 0.2° C. of the set point. The material is removed from the vacuum oven and taken directly to the plastometer. It is loaded quickly through the top of the barrel. A packing tool can be used to push material that becomes stuck on the sides of the barrel to the bottom of the barrel. Once the barrel is full, the instrument's piston rod is placed in the top of the barrel and a small amount of material is extruded through the orifice die located in the bottom of the barrel. The piston rod is then restrained from further extruding polyester until the resin has been exposed to a heat history of 5 minutes with a temperature set point of 295° C. At the end of the 5 minute holding period, the resin is quickly extruded into a bath of ice water. A long string of polyester will result from this process. The ends of this polymer string are discarded to reduce the chance of contamination from previous samples. Any plastometer type will work for this application. However, extrusion plastometers with automatic packing and extrusion rates will reduce the amount of variability seen in test results. The Ceast Model 7027 Modular Melt Flow instrument is an example of this type of plastometer.

Following the extrusion processing of the resin, the sample is cryogenically ground. It is stored inside a freezer to reduce the loss of acetaldehyde from the sample. A small amount of material (0.2 g) is loaded into a headspace GC vial and tested according to ASTM method F2013-00.

The results from the GC test are correlated to the results that would be obtained for materials molded into bottle preforms. The extruder barrel temperature and melt residence time of polyester material during an injection molding process has an effect upon the final level of acetaldehyde within bottle preforms. Table 1 summarizes the correlation that can be obtained between the residual acetaldehyde of preforms molded with a single set of molding conditions and the acetaldehyde level generated using extrusion plastometer processing with a hold time of 5 minutes inside the barrel at 295° C. for a range of polyester resins. The data in Table 1 show the correlation that is achieved when comparing a single set of operating conditions for molding bottle preforms and a single set of conditions for running the same resins through an extrusion plastometer. For data reported in Table 1, an injection temperature of 270° C. with a residence time of 2 minutes is used to make the preforms on which residual acetaldehyde levels were tested. Table 1 summarizes residual data via ASTM F2013-00 for correlation of the first screening method with the preform molding approach. All preforms are molded using identical conditions. Corresponding plastometer generated acetaldehyde levels are associated with each of the polyester resins. In this example, the plastometer holds the polyester material for 5 minutes with a set point temperature of 295° C. The plastometer type is a non-automated Custom Scientific Instruments Model Melt Index CS 127.

TABLE 1
Plastometer Generated Acetaldehyde
Correlation to Preform AA Levels

| Resin** | Average Preform AA | Average Plastometer AA |
|---|---|---|
| A | 3.94 | 16.73 |
| B | 4.93 | 19.55 |
| C | 6.29 | 25.03 |
| D | 6.18 | 22.82 |
| E | 10.05 | 32.85 |
| F | 12.81 | 26.77* |

*This value is an anomaly and is believed to represent a GC vial improperly sealed during testing such that some AA leaked out resulting in a lower AA level than would normally be seen.
**Each resin has a different composition or is made under different processing conditions.

### Example 2

The variability seen in this type of testing is reduced when using an extrusion plastometer with automated packing and extrusion of the resin. The data obtained in Table 1 is produced using a non-automated extrusion plastometer. The operator of the equipment is required to load the resin into the extrusion barrel, pack the resin with a metal rod to remove air pockets, and at the end of the processing extrude the resin from the barrel by applying force to the top of the piston rod.

In Table 2, a non-automated extrusion plastometer's capabilities are compared to that of a semi-automated extrusion plastometer. This version will automatically pack the sample for the operator and extrude it at the end of the processing time. As shown in Table 2, the variability of the test is reduced when the processing steps are somewhat automated. Reducing the test variability allows for detection of smaller differences between materials.

TABLE 2
Precision Comparison of Generated Acetaldehyde Levels Between
Non-Automated and Semi-Automated Extrusion Plastometers

| Plastometer Type | Average AA (ppm) | Standard Deviation AA (ppm) |
|---|---|---|
| Non-Automated | 20.0 | 1.6 |
| Semi-Automated | 18.2 | 0.7 |

Table 2 reports precision summary data of generated acetaldehyde levels for two extrusion plastometer types. The non-automated plastometer type is a Custom Scientific Instruments Model Melt Index CS 127. The semi-automated plastometer type is a Ceast Model 7027 Modular Melt Flow instrument. A single polyester resin is tested in each of the two instruments. Each instrument is operated at 295° C. with a material hold time of 5 minutes. A total of 50 samples are run on each instrument to determine the standard deviation.

The acetaldehyde generation rate of polyester resins processed in extrusion plastometers correlates with the level of acetaldehyde that a finished bottle preform will contain. The level of generated acetaldehyde correlates with the level of acetaldehyde within the preforms over a range of polyester materials. The correlation between the two depends upon the processing conditions for the preform molding process and also the plastometer extrusion process. Although non-automated extrusion plastometers are capable of producing a preform correlation, semi-automated models will reduce the variability of test results. This will increase the capability of the test to detect differences between materials. The use of extrusion plastometer processing in obtaining acetaldehyde generation rate measurements will reduce the effort needed to compare materials by requiring smaller quantities of materials, making the test ideal for research and development laboratory environments.

In a preferred embodiment, a fully-automated extrusion plastometer automates the following functions: loading and packing of the polymer into the barrel, exposing the polymer to a consistent heat history, and extruding the polymer at consistent rates regardless of polymer composition.

### Example 3

Laboratory scale injection molding equipment can also be used to generate acetaldehyde within polyester resins. A typical example of such equipment is the Mini-Jector model #55-1 “Wasp” injection molding machine. The amount of material required to run such a machine is greater than that required for an extrusion plastometer, but is still considerably less than what is required to mold preforms. To mold a part with the Mini-Jector model #55-1, 100 to 200 grams of material are required. This is at least 10 times the amount of material required for the extrusion plastometer. Molding preforms typically requires at least 50 pounds of material.

The procedure used to generate acetaldehyde in parts molded with the Mini-Jector (or any other small scale injection molding equipment or extruder) is similar to that done with extrusion plastometers. Because the single screw extrusion process of the injection molding machine increases the amount of shear experienced by the resins, the operating temperature of the Mini-Jector (or similar type instruments) is set at a lower level than the extrusion plastometer. Increased shear results in more localized hot spots due to shear heating. A typical operating temperature for the Mini-Jector would be 285° C. versus the 295° C. temperature of the extrusion plastometer. After drying, material is loaded into the feed hopper for the instrument. The material is then extruded into the extruder barrel and quickly purged out the end of the barrel two times. The extruder barrel is then filled with the maximum amount of polymer it can hold. The material is held for 5 minutes at 285° C. and then injected into a steel mold that has a temperature between 20 and 30° C. A typical injection pressure is 1000 psi. The mold is then removed and the remainder of material in the instrument is purged through the barrel. The molded part is removed from the mold and cryogenically ground. It is then stored in a freezer until it can be run by ASTM F2013-00 on a headspace GC instrument to determine the residual acetaldehyde level.

The repeatability of test results obtained with the laboratory scale injection molding machines is better than that seen with the extrusion plastometers. Even with a temperature set point 10° C. cooler than the extrusion plastometer, the level of acetaldehyde is higher with the Mini-Jector, due at least in part to more shear heating and/or more efficient melting, that is longer time in the melt, than in extrusion plastometers. On the same polyester material tested in the extrusion plastometers listed in Table 2, the Mini-Jector results has an average acetaldehyde level of 25.8 ppm and a standard deviation of 0.4 ppm. The reduced variability in the Mini-Jector results is attributed to a more automated equipment operation than either of the extrusion plastometers. The extrusion plastometer methods require that the operator manually fill the plastometer's barrel with polymer. The time it takes the operator to fill the barrel is a variable that depends on the properties of a given polymeric material and the operator. With the Mini-Jector, the instrument automatically feeds the material into the barrel via an extrusion screw set at a constant rotation speed. It consistently fills the injection barrel in the same amount of time regardless of the material properties or the identity of the operator. All of these instruments can be used in the measurement of acetaldehyde generation rates, which predict trends and can be used to also correlate with the residual acetaldehyde levels obtained in bottle preforms or other molded articles.

What we claim is:

1. An acetaldehyde screening method comprising providing a solid polymer sample particles having a free acetaldehyde (“AA”) content of 2 ppm or less, melting 500 grams or less of the sample particles to obtain a polymer sample having a heat history, and thereafter measuring the amount of acetaldehyde present in the polymer sample having the heat history.

2. The method of claim 1, wherein the polymer comprises a thermoplastic polyester polymer.

3. The method of claim 2, wherein the polyester polymer comprises repeating units of ethylene terephthalate or ethylene naphthalate.

4. The method of claim 1, wherein 120 grams or less of sample are employed in the method.

5. The method of claim 1, wherein the sample is melted in an extrusion plastometer.

6. The method of claim 5, wherein the extrusion plastometer is semi-automated.

7. The method of claim 1, wherein the sample particles have an average particle size of 10 mm or less.

8. The method of claim 7, wherein the sample particles have an average particle size of 5 mm or less.

9. The method of claim 1, wherein the sample particles are obtained by cryogenically grinding a solid polymer to a powder.

10. The method of claim 1, wherein the obtained polymer sample is cryogenically ground to a powder.

11. The method of claim 10, wherein the particle size is 5000 nm or less.

12. The method of claim 1, wherein the polymer sample having an AA content of 2 ppm or less is obtained by treating a solid polymer to reduce the amount of AA in the solid polymer to a level of less than 2 ppm.

13. The method of claim 1, wherein the amount of AA in the polymer sample is 1 ppm or less.

14. The method of claim 1, wherein the polymer sample represents a finished polymer as used in the manufacture of a molded article.

15. The method of claim 1, comprising treating the solid polymer particles to a process which ensures reduction of free AA content of polymer sample particles on average to a level of 2 ppm or less without measuring the actual AA content of each sample submitted to melting.

16. The method of claim 1, wherein the polymer sample particles are obtained by passing solid polymer particles through a 3 mm or less screen.

17. The method of claim 1, wherein the polymer sample particles having a free AA content of 2 ppm or less are obtained by stripping the AA from polymer particles.

18. The method of claim 15, wherein the stripping comprises exposing the polymer to a heat at a temperature set above the glass transition temperature Tg of the polymer and at least 20° C. below the melting temperature of the polymer.

19. The method of claim 1, wherein the polymer sample particles obtain an AA of 2 ppm or less by subjecting the polymer particles to a temperature within a range of 100° C. to 170° C.

20. The method of claim 17, wherein the residence time of the polymer particles within said temperature range is 16 hours or more.

21. The method of claim 1, wherein the solid polymer sample particles are melted and held as a melt for a time sufficient to generate AA.

22. The method of claim 1, wherein the solid polymer sample particles are melted and held as a melt for at least 3 minutes.

23. The method of claim 1, wherein the melt temperature set points are within a range of which simulate molding conditions.

24. The method of claim 1, wherein the melt temperature set points are within a range of 260° C. to 305° C.

25. The method of claim 1, wherein the polymer sample having a melt history is solidified and held in a state which diminishes or prevents the further generation of AA until the sample is subjected to analytical testing.

26. The method of claim 23, wherein the polymer sample having a heat history is extruded or forced from a melt chamber into a bath of cold liquid, ground, and placed in sub-zero Celsius conditions and thereafter subjected to analytical testing to measure its AA content.

27. The method of claim 1, wherein the AA content is measured by gas chromatography.

28. The method of claim 1, wherein the sample is melted in a laboratory-scale injection molding equipment or extruder

29. The method of claim 1, wherein the particles are heated prior to melting at a temperature within a range of 110° C. to 130° C. for 48 hours or more.

30. The method of claim 1, wherein the polymer sample particles obtain an AA level of 2 ppm or less and a water level of 50 ppm or less by subjecting the polymer particles to a temperature within a range of 180° C. to 200° C. for a time of 1 to 2 hours.

31. An acetaldehyde screening method comprising measuring the quantity of free acetaldehyde AA in solid polymer sample particles to obtain a first value AAf, melting at least a portion of the particles to obtain a sample having a heat history, and thereafter measuring the amount of acetaldehyde AA generated in the sample having a heat history to obtain a second value AAg.

32. The method of claim 31, wherein the polymer comprises a thermoplastic polyester polymer.

33. The method of claim 31, wherein the polyester polymer comprises repeating units of ethylene terephthalate or ethylene naphthalate.

34. The method of claim 31, wherein 120 grams or less of sample are employed in the method.

35. The method of claim 31, wherein the sample particles have an average particle size of 10 mm or less.

36. The method of claim 35, wherein the sample particles have an average particle size of 5 mm or less.

37. The method of claim 31, wherein the polymer sample particles obtain an AA of 2 ppm or less by subjecting the polymer particles to a temperature within a range of 100° C. to 170° C.

38. The method of claim 37, wherein the residence time of the polymer particles within said temperature range is 16 hours or more.

39. The method of claim 31, wherein the solid polymer sample particles are melted and held as a melt for a time sufficient to generate AA.

40. The method of claim 31, wherein the solid polymer sample particles are melted and held as a melt for at least 3 minutes.

41. The method of claim 31, wherein the melt temperature set points are within a range of 265° C. to 300° C.

42. The method of claim 31, wherein the polymer sample having a melt history is solidified and held in a state which diminishes or prevents the further generation of AA until the sample is subjected to analytical testing.

43. The method of claim 42, wherein the polymer sample having a heat history is extruded or forced from a melt chamber into a bath of cold liquid, ground, and placed in sub-zero Celsius conditions and thereafter subjected to analytical testing to measure its AA content.

44. The method of claim 31, wherein the solid polymer samples are heat treated to reduce the water content of the particles to 50 ppm or less.

45. The method of claim 31, wherein AAf is subtracted from AAt to obtain a value representing the amount of AA generated.

46. The method of claim 31, wherein the sample is melted in an extrusion plastometer.

47. The method of claim 46, wherein the extrusion plastometer is semi-automated.

48. The method of claim 31, wherein the sample is melted in a laboratory-scale injection molding equipment or extruder.
